(19) United States
(12) Patent Application Publication
(10) Pub. No.: US 2020/0319841 A1
(43) Pub. Date: Oct. 8, 2020

(54) AGENT APPARATUS, AGENT APPARATUS CONTROL METHOD, AND STORAGE MEDIUM

(71) Applicant: HONDA MOTOR CO., LTD., Tokyo (JP)

(72) Inventors: Yoshifumi Wagatsuma, Wako-shi (JP); Mototsugu Kubota, Wako-shi (JP); Toshikatsu Kuramochi, Tokyo (JP); Yusuke Oi, Tokyo (JP)

(21) Appl. No.: 16/822,049

(22) Filed: Mar. 18, 2020

(30) Foreign Application Priority Data
Mar. 26, 2019 (JP) 2019-057645

(51) Int. Cl. G06F 3/16; G06F 3/14

(52) U.S. Cl. CPC G06F 3/16; G06F 3/14

(57) ABSTRACT

An agent apparatus includes a display controller configured to perform control of causing a display to display an agent which provides a service including causing an output unit to output a response using speech in response to an utterance of an occupant of a vehicle, and a controller configured to control the agent on the basis of a situation of the occupant, an operating situation of the agent, and an operating situation of the vehicle, wherein, when interruption control occurs in the course of service provision according to the agent, the controller performs control of displaying interruption information that is information about the interruption and sub-interruption related information.

### CROSS-REFERENCE TO RELATED APPLICATION

Priority is claimed on Japanese Patent Application No. 2019-057645, filed Mar. 26, 2019, the content of which is incorporated herein by reference.

### BACKGROUND OF THE INVENTION

### Field of the Invention

The present invention relates to an agent apparatus, an agent apparatus control method, and a storage medium.

### Description of Related Art

A conventional technology related to an agent function of providing information about driving assistance, vehicle control, other applications, and the like at the request of an occupant of a vehicle while conversing with the occupant has been disclosed (Japanese Unexamined Patent Application, First Publication No. 2006-335231).

### SUMMARY OF THE INVENTION

In recent years, there have been cases in which a plurality of agent functions are mounted in a vehicle or functions provided by another device such as a navigation device and agent functions are simultaneously used. In such a case, an utterance of an agent may pause in a case in which, while an agent function is executed, another agent function or an interruption process performed by another device occurs, and the like. Countermeasures for such cases in which an utterance of an agent pauses have not been sufficiently studied. Accordingly, there are cases in which natural usability cannot be provided to occupants in the conventional technology.

An object of aspects of the present invention devised in view of such circumstances is to provide an agent apparatus, an agent apparatus control method, and a storage medium which can start or end provision of a service using an agent function with a more natural feeling of use.

To solve the aforementioned problem and accomplish the object, the present invention employs the following aspects.

(1): An agent apparatus according to an aspect of the present invention is an agent apparatus including: a display controller configured to perform control of causing a display to display an agent which provides a service including causing an output unit to output a response using speech in response to an utterance of an occupant of a vehicle; and a controller configured to control the agent on the basis of a situation of the occupant, an operating situation of the agent, and an operating situation of the vehicle, wherein, when interruption control occurs in the course of service provision according to the agent, the display controller performs control of displaying interruption information that is information about the interruption and sub-interruption related information.

(2): In the aspect of (2), the sub-interruption related information may be notification information with respect to the service being provided by the agent.

(3): In the aspect of (1) or (2), the display controller may perform control of canceling display of the sub-interruption related information and then perform control of canceling display of the interruption information.

(4): In the aspect of any one of (1) to (3), the service may be provided by each of a first agent and a second agent, and the display controller may limit display of the first agent when interruption control according to the second agent occurs in the course of display of the first agent.

(5): In the aspect of (4), the controller may end display of the sub-interruption related information and resume service provision according to the agent when the interruption control has ended.

(6): In the aspect of (5), the controller may temporarily stop service provision that has been being provided before the interruption control is started, and when the interruption control ends, resume the temporarily stopped service provision.

(7): In the aspect of (6), the controller may resume the service provision from the start of an utterance of the agent at a point in time at which the service provision is temporarily stopped.

(8): In the aspect of any one of (5) to (7), the controller may temporarily stop service provision that has been being provided before the interruption control is started, additionally continuously execute processing with respect to details of service provision that has been being provided before the interruption control is started, and when the interruption control ends, resume service provision according to the first agent on the basis of details of the temporarily stopped service provision and a result of the continuously executed processing.

(9): In the aspect of any one of (1) to (8), the controller may change a display mode of the sub-interruption related information on the basis of a waiting time during which service provision through the display is curbed.

(10): An agent apparatus control method according to an aspect of the present invention is a control method for controlling an agent apparatus including a display controller configured to perform control of causing a display to display an agent which provides a service including causing an output unit to output a response using speech in response to an utterance of an occupant of a vehicle, and a controller configured to control the agent on the basis of a situation of the occupant, an operating situation of the agent, and an operating situation of the vehicle, the control method including, when interruption control occurs in the course of service provision according to the agent, causing, by a computer of the agent apparatus, the display controller to perform control of displaying interruption information that is information about the interruption and sub-interruption related information.

(11): A computer-readable non-transitory storage medium according to an aspect of the present invention stores a program causing a computer to: perform control of causing a display to display an agent which provides a service including causing an output unit to output a response using speech in response to an utterance of an occupant of a vehicle; and control the agent on the basis of a situation of the occupant, an operating situation of the agent, and an operating situation of the vehicle, wherein, when interruption control occurs in the course of service provision according to the agent, the computer is caused to perform control of displaying interruption information that is information about the interruption and sub-interruption related information.

According to aspects of the present invention, it is possible to start or end provision of a service using an agent function with more natural feeling of use.

### BRIEF DESCRIPTION OF THE DRAWINGS

FIG. 1 is a configuration diagram of an agent system including an agent apparatus.

FIG. 2 is a diagram illustrating a configuration of an agent apparatus according to a first embodiment and apparatuses mounted in a vehicle.

FIG. 3 is a diagram illustrating an arrangement example of a display/operating device.

FIG. 4 is a diagram illustrating an arrangement example of a speaker unit.

FIG. 5 is a diagram illustrating parts of a configuration of an agent server and a configuration of an agent apparatus.

FIG. 6 is a diagram for describing processing performed by a sub-interruption controller.

FIG. 7 is a diagram for describing a relationship between a waiting time according to the sub-interruption controller and sub-interruption related information displayed on a first display.

FIG. 8 is a diagram for describing an example of display mode change according to the sub-interruption controller.

FIG. 9 is a diagram for describing another example of display mode change according to the sub-interruption controller.

FIG. 10 is a flowchart illustrating an example of a processing flow executed by the agent apparatus.

### DETAILED DESCRIPTION OF THE INVENTION

Hereinafter, embodiments of an agent apparatus, an agent apparatus control method, and a storage medium of the present invention will be described with reference to the drawings. An agent apparatus is an apparatus for realizing a part or all of an agent system. As an example of the agent apparatus, an agent apparatus which is mounted in a vehicle (hereinafter, a vehicle M) and includes a plurality of types of agent functions will be described below. An agent function is, for example, a function of providing various types of information based on a request (command) included in an utterance of an occupant of the vehicle M or mediating network services while conversing with the occupant. A plurality of types of agents may have different functions, processing procedures, controls, output modes, and details. Agent functions may include a function of performing control of an apparatus in a vehicle (e.g., an apparatus with respect to driving control or vehicle body control), and the like.

An agent function is realized, for example, using a natural language processing function (a function of understanding the structure and meaning of text), a conversation management function, a network search function of searching for other apparatuses through a network or searching for a predetermined database of a host apparatus, and the like in addition to a speech recognition function of recognizing speech of an occupant (a function of converting speech into text) in an integrated manner. Some or all of these functions may be realized by artificial intelligence (AI) technology. A part of a configuration for executing these functions (particularly, the speech recognition function and the natural language processing and interpretation function) may be mounted in an agent server (external device) which can communicate with an on-board communication device of the vehicle M or a general-purpose communication device included in the vehicle M. The following description is based on the assumption that a part of the configuration is mounted in the agent server and the agent apparatus and the agent server realize an agent system in cooperation. A service caused to virtually appear by the agent apparatus and the agent server in cooperation is referred to as an agent.

<Overall Configuration>

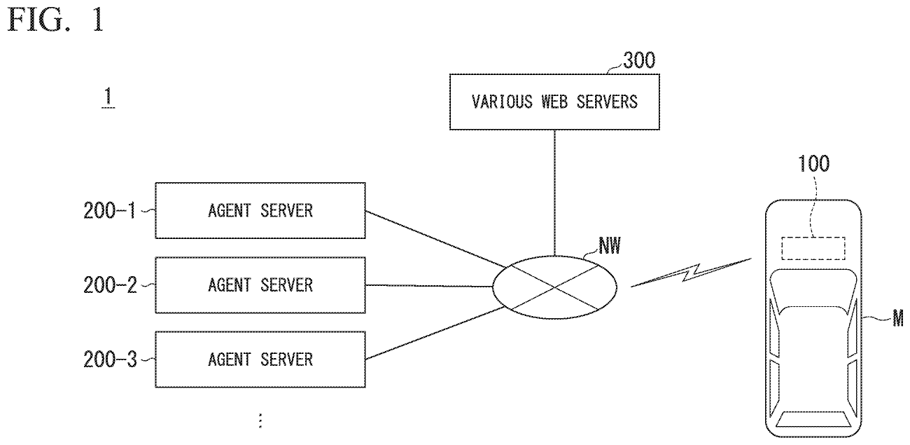

FIG. 1 is a configuration diagram of an agent system 1 including an agent apparatus 100. The agent system 1 includes, for example, the agent apparatus 100 and a plurality of agent servers 200-1, 200-2, 200-3, . . . . Numerals following the hyphens at the ends of reference numerals are identifiers for distinguishing agents. When agent servers are not distinguished, the agent servers may be simply referred to as an agent server 200. Although three agent servers 200 are illustrated in FIG. 1, the number of agent servers 200 may be two, four or more. The agent servers 200 are managed by different agent system providers. Accordingly, agents in the present invention are agents realized by different providers. For example, automobile manufacturers, network service providers, electronic commerce subscribers, cellular phone vendors and manufacturers, and the like may be conceived as providers, and any entity (a corporation, an organization, an individual, or the like) may become an agent system provider.

The agent apparatus 100 communicates with the agent server 200 via a network NW. The network NW includes, for example, some or all of the Internet, a cellular network, a Wi-Fi network, a wide area network (WAN), a local area network (LAN), a public line, a telephone line, a wireless base station, and the like. Various web servers 300 are connected to the network NW, and the agent server 200 or the agent apparatus 100 can acquire web pages from the various web servers 300 via the network NW.

The agent apparatus 100 makes a conversation with an occupant of the vehicle M, transmits speech from the occupant to the agent server 200 and presents a response acquired from the agent server 200 to the occupant in the form of speech output or image display.

### First Embodiment

### [Vehicle]

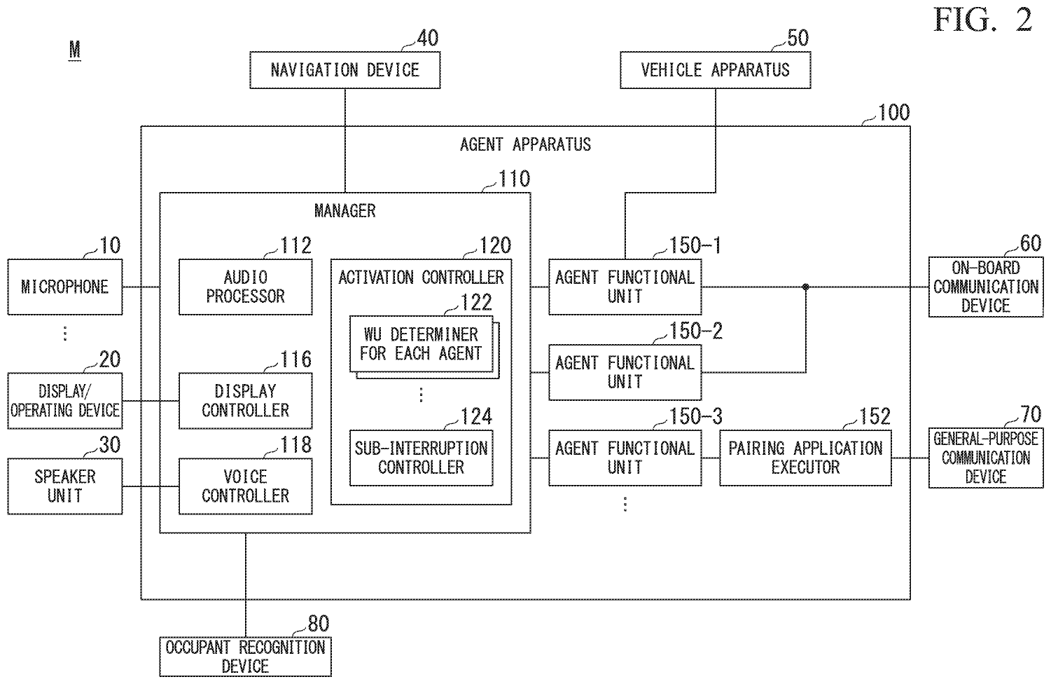

FIG. 2 is a diagram illustrating a configuration of the agent apparatus 100 according to a first embodiment and apparatuses mounted in the vehicle M. The vehicle M includes, for example, one or more microphones 10, a display/operating device 20, a speaker unit 30, a navigation device 40, a vehicle apparatus 50, an on-board communication device 60, an occupant recognition device 80, and the agent apparatus 100 mounted therein. There are cases in which a general-purpose communication device 70 such as a smartphone is included in a vehicle cabin and used as a communication device. Such devices are connected to each other through a multiplex communication line such as a controller area network (CAN) communication line, a serial communication line, a wireless communication network, or the like. The components illustrated in FIG. 2 are merely an example and some of the components may be omitted or other components may be further added.

The microphone 10 is an audio collector for collecting voice generated in the vehicle cabin. The display/operating device 20 is a device (or a group of devices) which can display images and receive an input operation. The display/operating device 20 includes, for example, a display device configured as a touch panel. Further, the display/operating device 20 may include a head up display (HUD) or a mechanical input device. The speaker unit 30 includes, for example, a plurality of speakers (voice output units) provided at different positions in the vehicle cabin. The display/operating device 20 may be shared by the agent apparatus 100 and the navigation device 40. This will be described in detail later.

The navigation device 40 includes a positioning device such as a navigation human machine interface (HMI) or a global positioning system (GPS), a storage device which stores map information, and a control device (navigation controller) which performs route search and the like. Some or all of the microphone 10, the display/operating device 20, and the speaker unit 30 may be used as a navigation HMI. The navigation device 40 searches for a route (navigation route) for moving to a destination input by an occupant from a position of the vehicle M identified by the positioning device and outputs guide information using the navigation HMI such that the vehicle M can travel along the route.

The route search function may be included in a navigation server accessible through the network NW. In this case, the navigation device 40 acquires a route from the navigation server and outputs guide information. The agent apparatus 100 may be constructed on the basis of the navigation controller. In this case, the navigation controller and the agent apparatus 100 are integrated in hardware. In the following description, there are cases in which a service provided by the navigation device 40 is referred to as a “navigation function.

The vehicle apparatus 50 includes, for example, a driving power output device such as an engine and a motor for traveling, an engine starting motor, a door lock device, a door opening/closing device, windows, a window opening/closing device, window opening/closing control device, seats, a seat position control device, a room mirror, a room mirror angle and position control device, illumination devices inside and outside the vehicle, illumination device control devices, wipers, a defogger, wiper and defogger control devices, winkers, a winker control device, an air-conditioning device, devices with respect to vehicle information such as information on a mileage and a tire pressure and information on the quantity of remaining fuel, and the like.

The on-board communication device 60 is, for example, a wireless communication device which can access the network NW using a cellular network or a Wi-Fi network.

The occupant recognition device 80 includes, for example, a seating sensor, an in-vehicle camera, an image recognition device, and the like.

The seating sensor includes a pressure sensor provided under a seat, a tension sensor attached to a seat belt, and the like. The in-vehicle camera is a charge coupled device (CCD) camera or a complementary metal oxide semiconductor (CMOS) camera provided in a vehicle cabin. The image recognition device analyzes an image of the in-vehicle camera and recognizes presence or absence, a face orientation, and the like of an occupant for each seat.

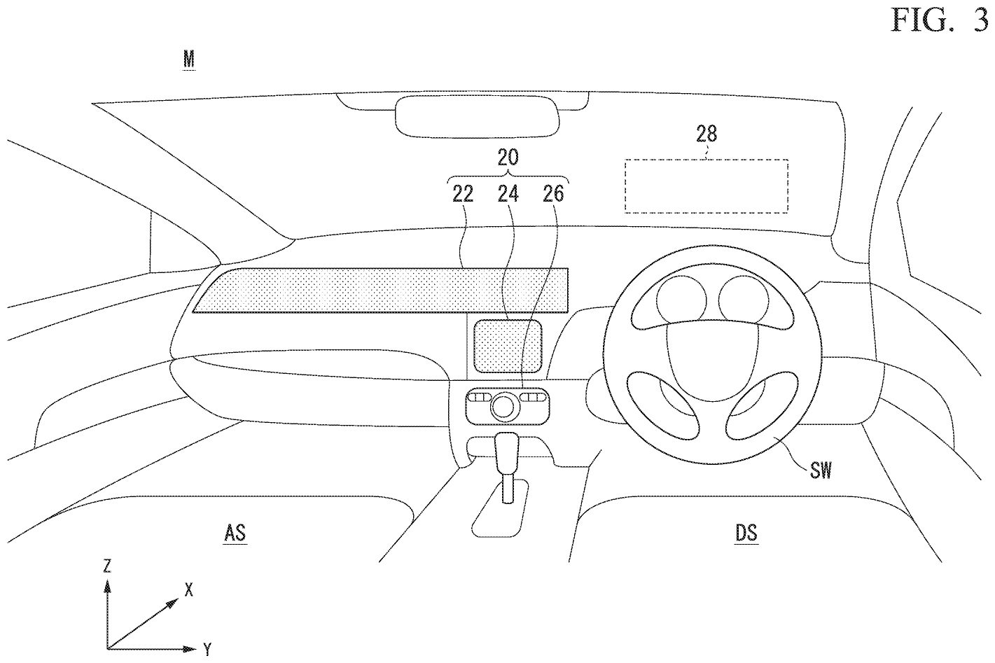

FIG. 3 is a diagram illustrating an arrangement example of the display/operating device 20. The display/operating device 20 may include a first display 22, a second display 24, and an operating switch ASSY 26, for example. The display/operating device 20 may further include an HUD 28.

The vehicle M includes, for example, a driver's seat DS in which a steering wheel SW is provided, and a passenger seat AS provided in a vehicle width direction (Y direction in the figure) with respect to the driver's seat DS. The first display 22 is a laterally elongated display device extending from the vicinity of the middle of the instrument panel between the driver's seat DS and the passenger seat AS to a position facing the left end of the passenger seat AS.

The second display 24 is provided in the vicinity of the middle region between the driver's seat DS and the passenger seat AS in the vehicle width direction under the first display. For example, both the first display 22 and the second display 24 are configured as touch panels and include a liquid crystal display (LCD), an organic electroluminescence (organic EL) display, a plasma display, or the like as a display. The operation switch ASSY 26 is an assembly of dial switches, button type switches, and the like. The display/operating device 20 outputs details of an operation performed by an occupant to the agent apparatus 100. Details displayed by the first display 22 or the second display 24 may be determined by the agent apparatus 100.

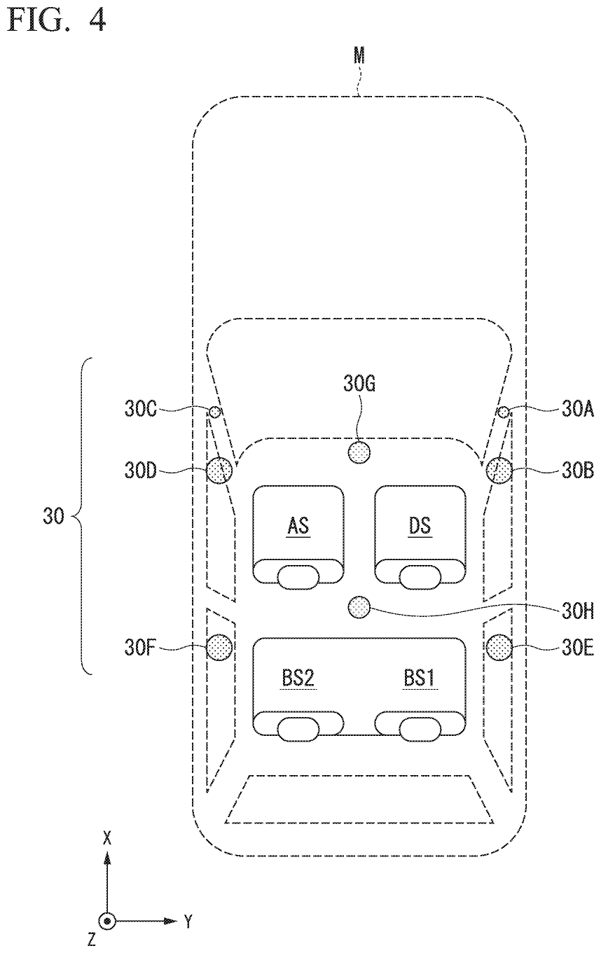

FIG. 4 is a diagram illustrating an arrangement example of the speaker unit 30. The speaker unit 30 includes, for example, speakers 30A to 30H. The speaker 30A is provided on a window pillar (so-called A pillar) on the side of the driver's seat DS. The speaker 30B is provided on the lower part of the door near the driver's seat DS. The speaker 30C is provided on a window pillar on the side of the passenger seat AS. The speaker 30D is provided on the lower part of the door near the passenger seat AS. The speaker 30E is provided on the lower part of the door near the right rear seat BS1. The speaker 30F is provided on the lower part of the door near the left rear seat BS2. The speaker 30G is provided in the vicinity of the second display 24. The speaker 30H is provided on the ceiling (roof) of the vehicle cabin.

In such an arrangement, a sound image is located near the driver's seat DS, for example, when only the speakers 30A and 30B are caused to output sound. When only the speakers 30C and 30D are caused to output sound, a sound image is located near the passenger seat AS. When only the speaker 30E is caused to output sound, a sound image is located near the right rear seat BS1. When only the speaker 30F is caused to output sound, a sound image is located near the left rear seat BS2. When only the speaker 30G is caused to output sound, a sound image is located near the front part of the vehicle cabin. When only the speaker 30H is caused to output sound, a sound image is located near the upper part of the vehicle cabin. The present invention is not limited thereto and the speaker unit 30 can locate a sound image at any position in the vehicle cabin by controlling distribution of sound output from each speaker using a mixer and an amplifier.

### [Agent Apparatus]

Referring back to FIG. 2, the agent apparatus 100 includes a manager 110, agent functional units 150-1, 150-2 and 150-3, and a pairing application executer 152. The manager 110 includes, for example, an audio processor 112, a display controller 116, a voice controller 118, and an activation controller 120. Hereinafter, when the agent functional units are not distinguished, they are simply referred to as an agent functional unit 150. Illustration of three agent functional units 150 is merely an example in which they correspond to the number of the agent servers 200 in FIG. 1 and the number of agent functional units 150 may be two, four or more. A software arrangement in FIG. 2 is illustrated in a simplified manner for description and can be arbitrarily modified, for example, such that the manager 110 may be interposed between the agent functional unit 150 and the on-board communication device 60 in practice.

Each component of the agent apparatus 100 is realized, for example, by a hardware processor such as a central processing unit (CPU) executing a program (software). Some or all of these components may be realized by hardware (a circuit including circuitry) such as a large scale integration (LSI) circuit, an application specific integrated circuit (ASIC), a field-programmable gate array (FPGA) or a graphics processing unit (GPU) or realized by software and hardware in cooperation. The program may be stored in advance in a storage device (storage device including a non-transitory storage medium) such as a hard disk drive (HDD) or a flash memory or stored in a separable storage medium (non-transitory storage medium) such as a DVD or a CD-ROM and installed when the storage medium is inserted into a drive device.

The agent functional unit 150 causes an agent to appear in cooperation with the agent server 200 corresponding thereto to provide a service including a response using speech according to an utterance of the occupant of the vehicle. The agent functional units 150 may include one authorized to control the vehicle apparatus 50. The agent functional unit 150 may include one that cooperates with the general-purpose communication device 70 via the pairing application executer 152 and communicates with the agent server 200.

For example, the agent functional unit 150-1 is authorized to control the vehicle apparatus 50. The agent functional unit 150-1 communicates with the agent server 200-1 via the on-board communication device 60. The agent functional unit 150-2 communicates with the agent server 200-2 via the on-board communication device 60. The agent functional unit 150-3 cooperates with the general-purpose communication device 70 via the pairing application executer 152 and communicates with the agent server 200-3. The pairing application executer 152 performs pairing with the general-purpose communication device 70 according to Bluetooth (registered trademark), for example, and connects the agent functional unit 150-3 to the general-purpose communication device 70. The agent functional unit 150-3 may be connected to the general-purpose communication device 70 according to wired communication using a universal serial bus (USB) or the like. There are cases below in which an agent that is caused to appear by the agent functional unit 150-1 and the agent server 200-1 in cooperation is referred to as agent 1, an agent that is caused to appear by the agent functional unit 150-2 and the agent server 200-2 in cooperation is referred to as agent 2, and an agent that is caused to appear by the agent functional unit 150-3 and the agent server 200-3 in cooperation is referred to as agent 3.

The manager 110 functions according to execution of an operating system (OS) or a program such as middleware.

The audio processor 112 performs audio processing on received sound such that the sound reaches a state in which it is suitable to recognize a wake-up word preset for each agent.

The display controller 116 causes the first display 22 or the second display 24 to display an image according to an instruction from the agent functional unit 150. Hereinafter, it is assumed that the first display 22 is used. The display controller 116 generates, for example, an image of a personified agent (hereinafter referred to as an agent image) that communicates with an occupant in the vehicle cabin and causes the first display 22 to display the generated agent image according to control of a part of the agent functional units 150. The agent image is, for example, an image in the form of speaking to the occupant. The agent image may include, for example, a face image from which at least an observer (occupant) can recognize an expression or a face orientation. For example, the agent image may have parts imitating eyes and a nose at the center of the face region such that an expression or a face orientation is recognized on the basis of the positions of the parts at the center of the face region. The agent image may be three-dimensionally perceived such that the face orientation of the agent is recognized by the observer by including a head image in the three-dimensional space or may include an image of a main body (body, hands and legs) such that an action, a behavior, a posture, and the like of the agent can be recognized. The agent image may be an animation image.

The voice controller 118 causes some or all speakers included in the speaker unit 30 to output speech according to an instruction from the agent functional unit 150. The voice controller 118 may perform control of locating a sound image of agent voice at a position corresponding to a display position of an agent image using a plurality of speaker units 30. The position corresponding to the display position of the agent image is, for example, a position predicted to be perceived by the occupant as a position at which the agent image is talking in the agent voice, and specifically, is a position near the display position of the agent image (for example, within 2 to 3 [cm]). “Locating a sound image” is, for example, to determine a spatial position of a sound source perceived by the occupant by controlling the magnitude of sound transmitted to the left and right ears of the occupant.

The activation controller 120 controls the agent functional unit 150 on the basis of a situation of the occupant, an operating situation of the vehicle M including other apparatuses in addition to the agent apparatus 100, and an operating state of the agent functional unit 150. The activation controller 120 is an example of a “controller.”

The activation controller 120 includes, for example, a wake-up (WU) determiner 122 for each agent, and a sub-interruption controller 124.

The WU determiner 122 for each agent is present corresponding to each of the agent functional units 150-1, 150-2 and 150-3 and recognizes a wake-up word predetermined for each agent. The WU determiner 122 for each agent recognizes, from voice on which audio processing has been performed (voice stream), the meaning of the voice. First, the WU determiner 122 for each agent detects a voice section on the basis of amplitudes and zero crossing of voice waveforms in the voice stream. The WU determiner 122 for each agent may perform section detection based on speech recognition and non-speech recognition in units of frames based on Gaussian mixture model (GMM).

Subsequently, the WU determiner 122 for each agent converts the voice in the detected voice section into text to obtain text information. Then, the WU determiner 122 for each agent determines whether the text information corresponds to a wake-up word. When it is determined that the text information corresponds to a wake-up word, the WU determiner 122 for each agent activates a corresponding agent functional unit 150. The function corresponding to the WU determiner 122 for each agent may be mounted in the agent server 200. In this case, the manager 110 transmits the voice stream on which audio processing has been performed by the audio processor 112 to the agent server 200, and when the agent server 200 determines that the voice stream is a wake-up word, the agent functional unit 150 is activated according to an instruction from the agent server 200. Each agent functional unit 150 may be constantly activated and perform determination of a wake-up word by itself. In this case, the manager 110 need not include the WU determiner 122 for each agent.

The sub-interruption controller 124 performs control of ending service provision of the activated agent functional unit 150 (hereinafter, sub-interruption control) when another device (for example, the navigation device 40 or the vehicle apparatus 50) or another agent functional unit 150 activates processing of providing another service in an interrupting manner while the agent functional unit 150 causes the display/operating device 20 to display an agent to provide a service. Sub-interruption control executed by the sub-interruption controller 124 will be described later.

### [Agent Server]

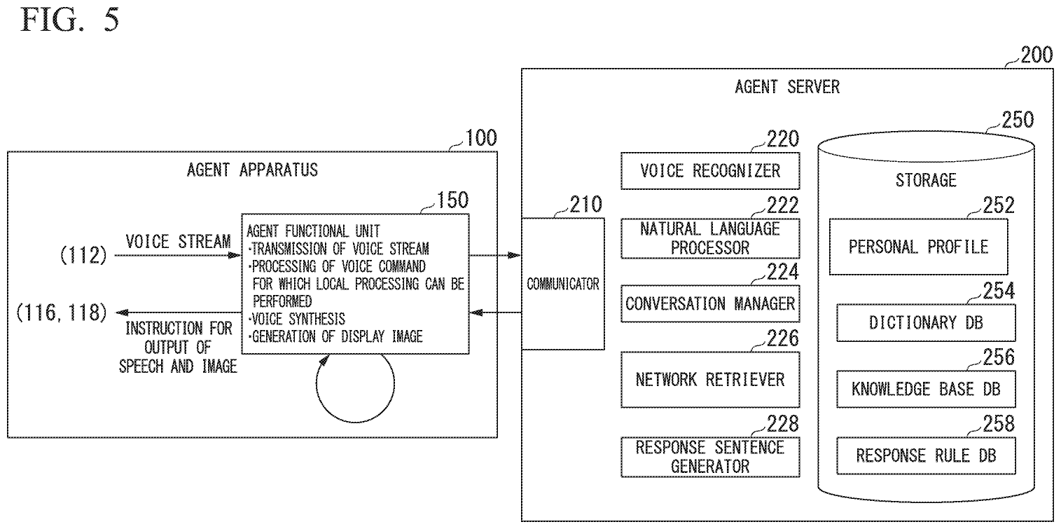

FIG. 5 is a diagram illustrating parts of the configuration of the agent server 200 and the configuration of the agent apparatus 100. Hereinafter, the configuration of the agent server 200 and operations of the agent functional unit 150, and the like will be described. Here, description of physical communication from the agent apparatus 100 to the network NW will be omitted.

The agent server 200 includes a communicator 210. The communicator 210 is, for example, a network interface such as a network interface card (NIC). Further, the agent server 200 includes, for example, a voice recognizer 220, a natural language processor 222, a conversation manager 224, a network retriever 226, and a response sentence generator 228. These components are realized, for example, by a hardware processor such as a CPU executing a program (software). Some or all of these components may be realized by hardware (a circuit including circuitry) such as an LSI circuit, an ASIC, an FPGA or a GPU or realized by software and hardware in cooperation.

The program may be stored in advance in a storage device (a storage device including a non-transitory storage medium) such as an HDD or a flash memory or stored in a separable storage medium (a non-transitory storage medium) such as a DVD or a CD-ROM and installed when the storage medium is inserted into a drive device.

The agent server 200 includes a storage 250. The storage 250 is realized by the above-described various storage devices. The storage 250 stores data such as a personal profile 252, a dictionary database (DB) 254, a knowledge base DB 256, and a response rule DB 258 and programs.

In the agent apparatus 100, the agent functional unit 150 transmits a voice stream or a voice stream on which processing such as compression or encoding has been performed to the agent server 200. When a voice command which can cause local processing (processing performed without the agent server 200) to be performed is recognized, the agent functional unit 150 may perform processing requested through the voice command. The voice command which can cause local processing to be performed is a voice command to which a reply can be given by referring to the storage (not shown) included in the agent apparatus 100 or a voice command for controlling the vehicle apparatus 50 (for example, a command for turning on an air-conditioning device, or the like) in the case of the agent functional unit 150-1. Accordingly, the agent functional unit 150 may include some functions of the agent server 200.

When the voice stream is acquired, the voice recognizer 220 performs voice recognition and outputs text information and the natural language processor 222 performs semantic interpretation on the text information with reference to the dictionary DB 254. The dictionary DB 254 is a DB in which abstracted semantic information is associated with text information. The dictionary DB 254 may include information on lists of synonyms. Steps of processing of the voice recognizer 220 and steps of processing of the natural language processor 222 are not clearly separated from each other and may affect each other in such a manner that the voice recognizer 220 receives a processing result of the natural language processor 222 and corrects a recognition result.

When a meaning such as “Today's weather” or “How is the weather today?” is recognized as a recognition result, for example, the natural language processor 222 generates a command replaced with standard text information of “today's weather”. Accordingly, even when a request voice includes variations in text, it is possible to easily make a conversation suitable for the request. The natural language processor 222 may recognize the meaning of text information using artificial intelligence processing such as machine learning processing using probabilities and generate a command based on a recognition result, for example.

The conversation manager 224 determines details of an utterance for the occupant of the vehicle M with reference to the personal profile 252, the knowledge base DB 256 and the response rule DB 258 on the basis of a processing result (command) of the natural language processor 222. The personal profile 252 includes personal information, preferences, past conversation histories, and the like of occupants stored for each occupant. The knowledge base DB 256 is information defining relationships between objects. The response rule DB 258 is information defining operations (replies, details of apparatus control, or the like) that need to be performed by agents for commands.

The conversation manager 224 may identify an occupant by collating the personal profile 252 with feature information acquired from a voice stream. In this case, personal information is associated with the voice feature information in the personal profile 252, for example. The voice feature information is, for example, information about features of a talking manner such as a voice pitch, intonation and rhythm (tone pattern), and feature quantities according to Mel Frequency Cepstrum Coefficients and the like. The voice feature information is, for example, information obtained by allowing the occupant to utter a predetermined word, sentence, or the like when the occupant is initially registered and recognizing the speech.

The conversation manager 224 causes the network retriever 226 to perform retrieval when the command is to request information that can be retrieved through the network NW. The network retriever 226 access the various web servers 300 via the network NW and acquires desired information. “Information that can be retrieved through the network NW” may be evaluation results of general users of a restaurant near the vehicle M or a weather forecast corresponding to the position of the vehicle M on that day, for example.

The response sentence generator 228 generates a response sentence and transmits the generated response sentence to the agent apparatus 100 such that details of the utterance determined by the conversation manager 224 are delivered to the occupant of the vehicle M. When the occupant is identified as an occupant registered in the personal profile, the response sentence generator 228 may generate a response sentence for calling the name of the occupant or in a speaking manner similar to the speaking manner of the occupant.

When the agent functional unit 150 acquires the response sentence, the agent functional unit 150 instructs the voice controller 118 to perform voice synthesis and output speech. The agent functional unit 150 instructs the display controller 116 to display an agent image suited to speech output. In this manner, an agent function in which an agent that has virtually appeared replies to the occupant of the vehicle M is realized.

### [Sub-Interruption Control]

Hereinafter, sub-interruption control executed in the sub-interruption controller 124 will be described.

Sub-interruption processing is processing of temporarily ending service provision of an agent functional unit 150 in operation and resuming service provision of the agent functional unit 150 after termination of information provision according to an external device or another agent function when service provision according to the external device or another agent functional unit 150 which has been set in advance by a user to be prioritized over service provision of the agent functional unit 150 is activated in the course of service provision of the agent functional unit 150. Sub-interruption processing is, for example, processing occurring when information having a high degree of urgency for an occupant and information set to be preferentially notified of the occupant, such as reception of a call, a message, and the like, an alarm, notification of a point of interest (POI) according to the navigation device 40, and alert of reduction in the remaining on-board battery power level, and the like, are provided. In the following description, there are cases in which processing performed by an external device or another agent functional unit 150 which causes sub-interruption control to start is referred to as “interruption processing.”

When display of information related to a service provided by an agent functional unit 150 on the first display 22 and an utterance of an agent are ended due to start of sub-interruption processing, the sub-interruption controller 124 may perform some pre-processing (for example, screen display for notifying a user of switching displayed details, utterances such as “Just a moment, please,” “Agent service will be stopped,” and the like for notifying an occupant of switching of displayed details according to an agent function, gradually decreasing the volume of utterances of an agent, generating an alarm sound representing start of interruption processing, and the like) until the display and the utterance are completely ended or the display and the utterance may be immediately ended, and control by the external device or the other agent functional unit 150 performing interruption processing may be started. Hereinafter, display immediately before start of the aforementioned sub-interruption processing will be referred to as “sub-interruption start control.”

When the sub-interruption controller 124 ends the sub-interruption processing, the sub-interruption controller 124 resumes display of the information related to the service provided by the agent functional unit 150 on the first display 22 and the utterance of the agent which have been ended due to interruption. The sub-interruption controller 124 may resume service provision from a position at which the display and the utterance that had been being provided when sub-interruption control was started had been stopped, cause restatement to be performed from the start of an initial utterance in service provision or an uttered sentence during the utterance, which is a position at which the display and the utterance are easily paused, retroact to the beginning of the ended utterance and resume service provision, or perform display and utterance different from information displayed before service provision was ended due to sub-interruption control. When sub-interruption control has ended, how the agent functional unit 150 resumes service provision may be set in advance by the occupant or determined by the agent functional unit 150 each time on the basis of an utterance of the occupant collected through the microphone 10 as a result of recognition of positional information of the vehicle M when sub-interruption control ends, a state of the occupant, and the like through the occupant recognition device 80 as in general service provision.

Although description will be given on the assumption that interruption processing according to the navigation device 40 occurs in the course of service provision of the agent functional unit 150-1, the present invention is not limited thereto and control in the same manner may also be performed, for example, in a case in which interruption processing according to the agent functional unit 150-2 occurs in the course of service provision of the agent functional unit 150-1, and the like. Description is based on the assumption that the first display 22 is shared by the agent apparatus 100 and the navigation device 40. An agent function realized by the agent functional unit 150-1 is an example of a “first agent.”

In the following description, there are cases in which information displayed on the first display 22 according to interruption processing of the navigation device 40 is referred to as “interruption information.”

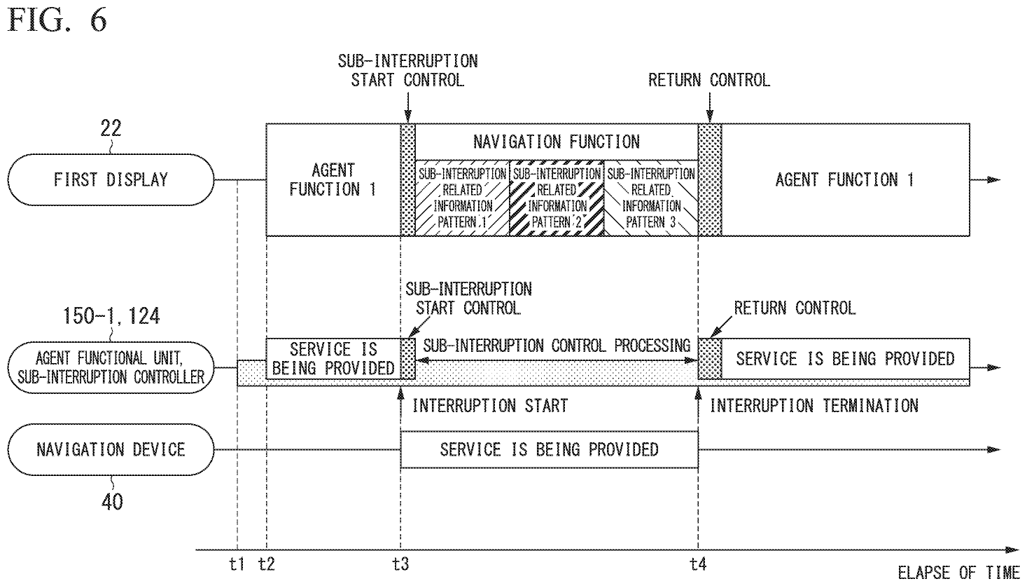

FIG. 6 is a diagram for describing processing performed by the sub-interruption controller 124. The first display 22 receives no display input from the agent functional unit 150-1 and the navigation device 40 and projects nothing before a time t1. When the WU determiner 122 for each agent recognizes an utterance of a wake-up word of an occupant at the time t1 or activation conditions reserved and set in advance are satisfied, the manager 110 causes the sub-interruption controller 124 to determine whether agent function 1 of the agent functional unit 150-1 may be displayed on the first display 22. The sub-interruption controller 124 confirms that other devices or other agent functions are not activated and determines that agent function 1 may be displayed. Thereafter, the sub-interruption controller 124 performs processing for receiving interruption processing according to other functions (e.g., interruption determination processing) until service provision according to agent function 1 ends. The interruption determination processing is repeatedly performed at an interval of about 0.5 [sec]. The manager 110 causes the first display 22 to display agent function 1 according to the agent functional unit 150 to start service provision on the basis of a result of interruption determination processing performed by the sub-interruption controller 124 from a point in time t2 and an utterance of the occupant after the time t1 or details of service provision reserved and set in advance.

The navigation device 40 instructs the manager 110 to output a command for causing the first display 22 to display interruption information at a time t3. The sub-interruption controller 124 determines that interruption according to the navigation device 40 will start as a result of interruption determination, ends display and utterance according to the displayed agent function 1, and causes the first display 22 to display a navigation function executed by the navigation device 40. Here, the sub-interruption controller 124 may cause the first display 22 to display information based on sub-interruption start control. Here, the agent functional unit 150-1 may cause the first display 22 to display some sort of indication (hereinafter, sub-interruption related information) indicating that agent function 1 is executing sub-interruption control processing. The sub-interruption related information is notification information with respect to the service that has been being provided by the agent functional unit 150-1 and, for example, text information, an icon, or the like that represents that sub-interruption control is being executed.

The sub-interruption controller 124 may change a display mode of the sub-interruption related information on the basis of a waiting time during which service provision according to agent function 1 through the first display 22 is curbed. In this case, sub-interruption control information in a plurality of patterns may be displayed, as illustrated in FIG. 6.

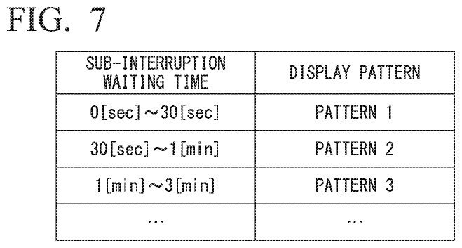

FIG. 7 is a diagram for describing a relationship between a waiting time according to the sub-interruption controller 124 and sub-interruption related information displayed on the first display 22. For example, the sub-interruption controller 124 sets a display mode of agent function 1 to display pattern 1 when the waiting time is less than 30 [sec] and changes the display mode of agent function 1 from display pattern 1 to display pattern 2 when the waiting time is equal to or longer than 30 [sec]. Further, the sub-interruption controller 124 changes the display mode of agent function 1 from display pattern 2 to display pattern 3, for example, when the waiting time is equal to or longer than 1 [min]. Such a relationship between the waiting time and the display mode may be set in advance by a manufacturer of the agent apparatus 100 or settings may be changed by the occupant of the vehicle M. Specific examples of the display patterns 1 to 3 will be described later.

Referring back to FIG. 6, the navigation device 40 notifies the sub-interruption controller 124 of completion of interruption processing when service provision ends at a time t4. The sub-interruption controller 124 resumes the display and utterance of agent function 1 according to the agent functional unit 150-1. Here, the sub-interruption controller 124 may perform display and utterance (hereinafter, return control) for notifying the occupant that the first display 22 has been caused to resume service provision according to agent function 1. The sub-interruption controller 124 displays, on the first display 22, a comment for inducing the occupant to make an utterance or operation for representing whether to resume display of agent function 1 as the return control, for example. The sub-interruption controller 124 resumes service provision of agent function 1 or ends agent function 1 as it is on the basis of the utterance or operation of the occupant associated with the return control. The return control is not limited to control based on an utterance of the occupant and may be, for example, display of text information displayed for about 5 [sec] or an utterance such as “Service will be resumed” given by an agent. For example, a response upper limit time of about 30 [sec] is provided for the return control, and when an utterance or an operation of the occupant is not confirmed within the response upper limit time, service provision of agent function 1 may be ended.

The sub-interruption controller 124 resumes display of agent function 1 according to the agent functional unit 150-1 after the return control has ended.

### Modified Example 1 of Display Mode

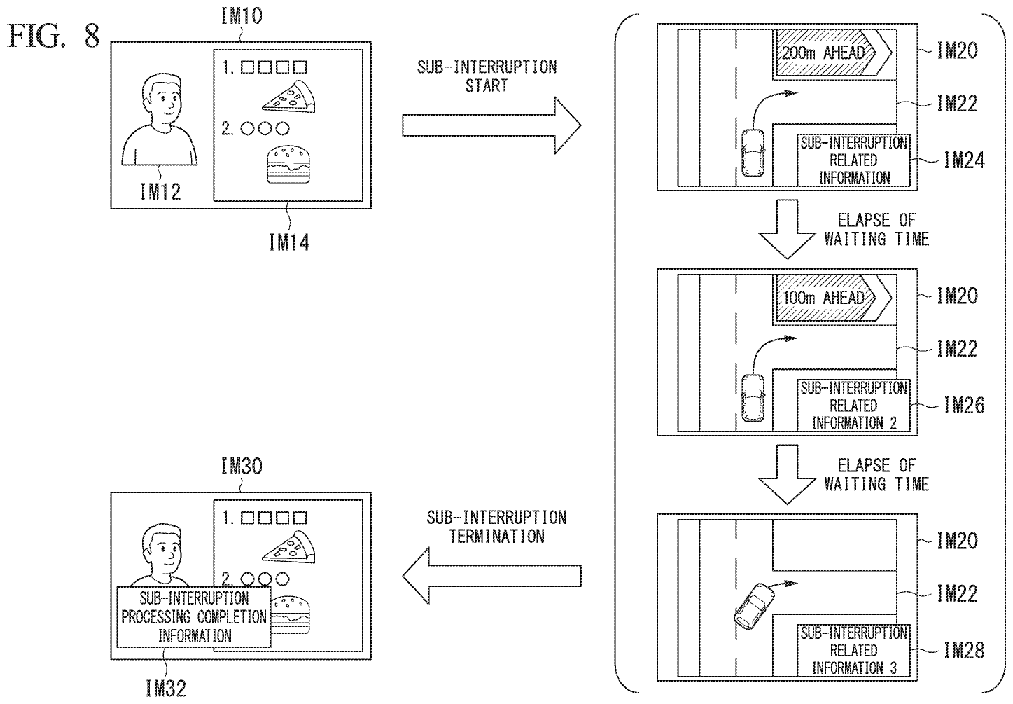

The sub-interruption controller 124 changes details of display in the first display 22, for example, on the basis of an elapsed time (hereinafter, a waiting time) from the start of sub-interruption processing of the agent functional unit 150. FIG. 8 is a diagram for describing an example of display mode change according to the sub-interruption controller 124. Description will be given on the assumption that interruption processing according to the navigation device 40 occurs while the agent functional unit 150-1 provides a service related to information about restaurants at which the vehicle M may stop by during traveling.

The left part of FIG. 8 is a screen image IM10 displayed on the first display 22 before sub-interruption control processing of the sub-interruption controller 124 is performed. The screen image IM10 includes, for example, an agent image IM12 and an image IM14 including information associated with a service provided by the agent functional unit 150. The image IM14 includes, for example, text information, image information, and the like based on information that can be retrieved via the network NW.

The center part of FIG. 8 is a screen image IM20 displayed on the first display 22 in the course of sub-interruption control performed by the sub-interruption controller 124. The screen image IM20 includes, for example, an image IM22 regarding interruption information displayed according to the navigation device 40 and an image IM24 regarding sub-interruption related information. The image IM24 includes, for example, text information such as “Please, wait a moment.”

The sub-interruption controller 124 may change the sub-interruption related information on the basis of a waiting time, as illustrated in FIG. 7. The sub-interruption controller 124 displays the image IM24 in pattern 1 of the display patterns illustrated in FIG. 7, for example, and when the waiting time exceeds 30 [sec], displays the image IM26 associated with sub-interruption related information (hereinafter, sub-interruption related information 2) including information different from the image IM24 in pattern 2 of the display patterns. The image IM26 includes, for example, text information such as “Waiting for termination of navigation.” When the waiting time exceeds 1 [min], for example, the sub-interruption controller 124 displays an image IM28 associated with sub-interruption related information (hereinafter, sub-interruption related information 3) including information different from the image IM24 and the image IM26 in pattern 3 of the display patterns. The image IM28 includes, for example, text information such as “Agent function will be resumed soon.” When the waiting time has not reached 30 [sec] or 1 [min] that is a display pattern change threshold value, the sub-interruption controller 124 may not perform display patterns change.

That is, when the waiting time is short, there is a possibility that the illustrated images IM26 and IM28 are not displayed.

The right part of FIG. 8 is a screen image IM30 displayed on the first display 22 before sub-interruption control processing performed by the sub-interruption controller 124 ends. The screen image IM30 includes, for example, a screen image IM30 including the agent image IM12 and the image IM14 including information associated with the services provided by the agent functional unit 150, which is the same as that before sub-interruption processing is started, and an image IM32 including sub-interruption processing termination information. The image IM32 includes, for example, information representing resumption of service provision according to agent function 1. Display of the image IM32 may be omitted. In this case, an utterance for notifying the occupant of resumption of service provision according to agent function 1 may be performed or the utterance may be omitted.

### Modified Example 2 of Display Mode

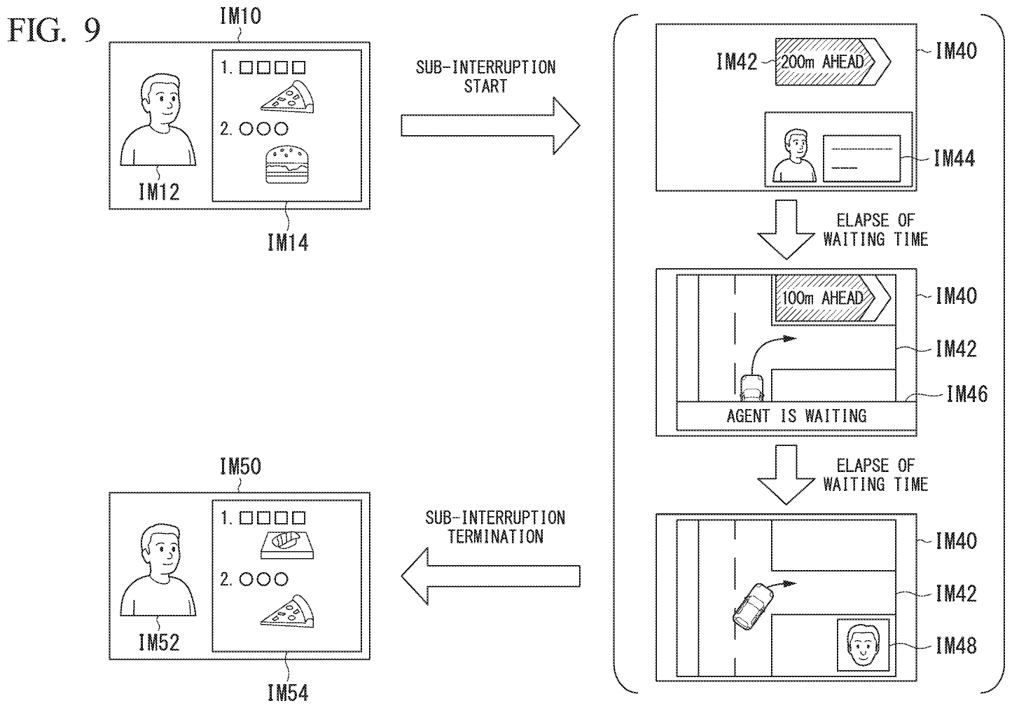

The sub-interruption controller 124 gradually decreases a display proportion of sub-interruption related information in the first display 22 or gradually reduces the amount of information, for example, on the basis of a waiting time during which service provision according to the agent functional unit 150 is curbed. FIG. 9 is a diagram for describing another example of display mode change according to the sub-interruption controller 124.

The left part of FIG. 9 is a screen image IM10 displayed on the first display 22 before sub-interruption control processing according to the sub-interruption controller 124 is executed as in the left part of FIG. 8.

The center part of FIG. 9 is a screen image IM40 displayed on the first display 22 in the course of sub-interruption control performed by the sub-interruption controller 124. The screen image IM40 includes, for example, an image IM42 regarding interruption information displayed according to the navigation device 40 and an image IM44 regarding sub-interruption related information. The image IM42 is, for example, a POI notification image. The image IM44 includes, for example, reduced display of the screen image IM10. The sub-interruption controller 124 may change display positions and image sizes of the image IM42 and the image IM44 as sub-interruption control or change the amounts of information displayed by the image IM42 and the image IM44 (for example, the amounts of text included in the images) as sub-interruption control.

The sub-interruption controller 124 displays the image IM44 in pattern 1 of the display patterns, for example, and when the waiting time exceeds 30 [sec], displays the image IM46 associated with sub-interruption related information including information different from the image IM44 in pattern 2 of the display patterns, as in the modified example illustrated in FIG. 8. The sub-interruption controller 124 decreases the amount of information of the image IM46 to be less than that of the image IM44 or decreases the display size of the image IM46 to be less than that of the image IM44. When the waiting time exceeds 1 [min], for example, the sub-interruption controller 124 displays an image IM48 associated with sub-interruption related information including information different from the image IM44 and the image IM46 in pattern 3 of the display patterns. The sub-interruption controller 124 decreases the amount of information included in the image IM48 to be less than those of the image IM44 and the image IM46 or decreases the display size of the image IM48 to be less than those of the image IM44 and the image IM46. The image IM48 includes, for example, an icon indicating that the agent function is waiting.

### Modified Example 3 of Display Mode

The sub-interruption controller 124 may continuously execute processing of updating details of service provision of agent function 1 during sub-interruption control. When the display example of FIG. 9 is taken as an example, the sub-interruption controller 124 continuously acquires information displayed in the image IM14 if no interruption occur even when the screen image IM40 regarding the service provided by the navigation device 40 is displayed during sub-interruption processing and provides updated information when sub-interruption processing ends.

The left part of FIG. 9 is a screen image IM50 displayed on the first display 22 before sub-interruption control processing performed by the sub-interruption controller 124 ends. The screen image IM50 includes, for example, an agent image IM52 and an image IM54 including information associated with the service provided by the agent functional unit 150 which is different from the screen image IM10 before sub-interruption processing is started. The image IM54 may include different information updated from information included in the image IM14. This processing is useful when an information source of information included in the image IM14 is information that can be retrieved via the network NW and the information is frequently updated (for example, when the information source is a social networking service (SNS) or microblog) or changes according to the current position of the vehicle M.

Although the first display 22 chiefly displays a single agent function controlled by the agent apparatus 100 or information according to other devices in the above description, when a plurality of displays are provided as illustrated in FIG. 3, the agent apparatus 100 may control display details of the respective displays. For example, when sub-interruption control occurs while the first display 22 is caused to display an agent function for service provision, the HUD 28 may be caused to display interruption information, the first display 22 may be caused to continue to display the agent function, and control of temporarily stopping service provision by ending only an utterance of an agent may be performed. In this case, the sub-interruption controller 124 may further perform processing of reducing visibility such as reducing the luminance of screen display of the agent function during sub-interruption control such that the occupant easily pays attention to the HUD 28.

The above-described sub-interruption control may also be performed when agent 2 (an example of a “second agent”) controlled by another agent functional unit 150-2 performs interruption processing in the course of service provision of agent 1 (the first agent) controlled by the agent functional unit 150-1.

For example, when services are respectively provided by agent 1 and agent 2 and interruption control according to agent 2 occurs during display of agent 1, the display controller 116 and the sub-interruption controller 124 limit display of agent 1 as illustrated in (2) to (4) of an example of processing of service provision according to a plurality of agents shown below.

<Example of Processing of Service Provision According to a Plurality of Agents>

(1) Display of agent 1 and service provision

(2) Display of occurrence of interruption control according to agent 2 and display of sub-interruption related information with respect to (1)

(3) Display of interruption information according to agent 2 and display of sub-interruption related information with respect to (1)

(4) Termination of interruption control according to agent 2

(5) Returning display of agent 1 to state of (1)

In (4), the display controller 116 performs control of canceling display of sub-interruption related information with respect to agent 1 and then performs control of canceling interruption information according to agent 2. In (2) and (3), interruption information provided by the displayed agent 2 may be displayed, for example, in a popup notification form.

### [Processing Flow]

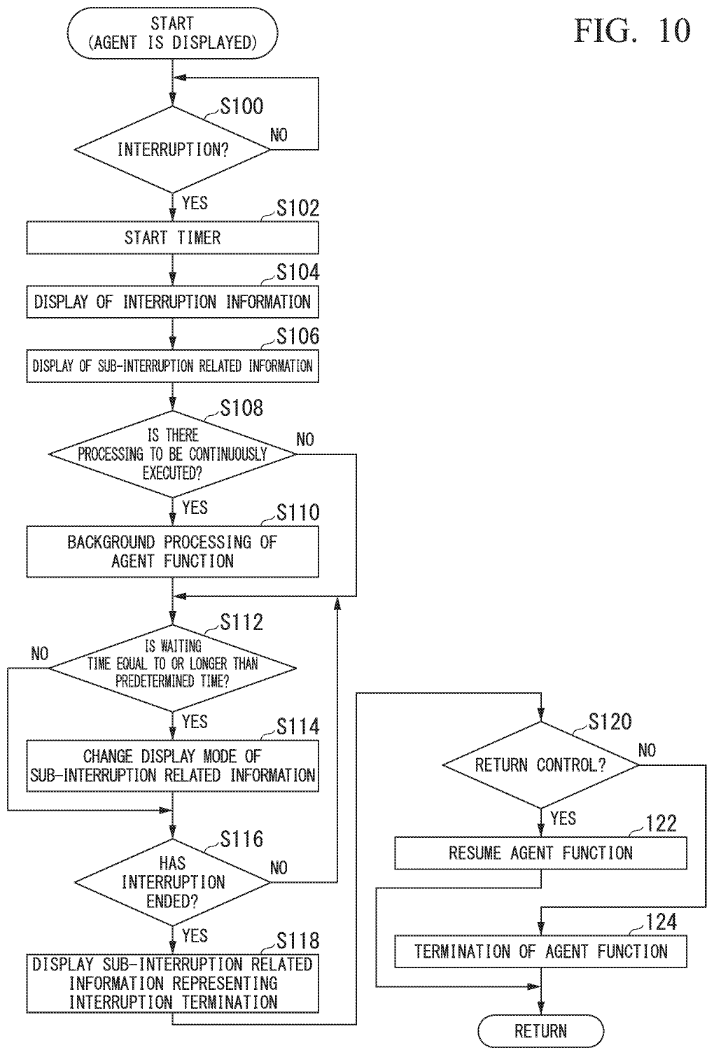

FIG. 10 is a flowchart illustrating an example of a processing flow executed by the agent apparatus 100. The processing flow illustrated in FIG. 10 is, for example, processing performed while the agent functional unit 150 displays an agent to provide a service.

First, the sub-interruption controller 124 determines whether a notification of interruption according to another device is received (step S100). When it is determined that the interruption notification is not received, the sub-interruption controller 124 re-performs the process of step S100 after an elapse of specific time. When it is determined that the interruption notification is received, the sub-interruption controller 124 causes a timer for measuring a waiting time to start (step S102), starts display of interruption information (step S104) and additionally starts display of sub-interruption related information (step S106). The processes of step S104 and step S106 may be simultaneously started or the process of step S104 may be started after the process of step S106 is started.

Next, the sub-interruption controller 124 determines whether there is processing to be continuously executed in service provision information that is displayed (or scheduled to be displayed) by the agent functional unit 150 before sub-interruption control is started (step S108). When it is determined that there is processing to be continuously executed, the sub-interruption controller 124 causes the agent functional unit 150 to execute the processing to be continuously executed in background (step S110). When it is determined that there is no processing to be continuously executed, processing proceeds to step S112.

Next, the sub-interruption controller 124 determines whether the waiting time is equal to or longer than a predetermined time on the basis of the timer that has started measurement of the waiting time in step S102 (step S112). When it is determined that the waiting time is equal to or longer than the predetermined time, the sub-interruption controller 124 changes a display mode of the sub-interruption related information (step S114). When it is not determined that the waiting time is equal to or longer than the predetermined time, the sub-interruption controller 124 proceeds to step S116.

Next, the sub-interruption controller 124 determines whether a notification of interruption termination is received from another device (step S116). When it is not determined that a notification of interruption termination is received, the sub-interruption controller 124 returns processing to step S112. When it is determined that a notification of interruption termination is received, the sub-interruption controller 124 displays sub-interruption related information representing interruption termination (step S118) and receives an utterance or an operation of the occupant with respect to whether return control will be performed (step S120). When return control is performed, the manager 110 resumes service provision according to the agent functional unit 150 (step S122). When return control is not performed, the manager 110 ends service provision according to the agent functional unit 150 (step S124). Description of processing of this flowchart ends.

According to the agent apparatus 100 according to the above-described first embodiment, it is possible to provide services with a natural feeling of use for an occupant in such a manner that interruption processing according to another device or the like is received, service provision according to an agent function is temporarily stopped, and service provision according to the agent function is resumed or ended when interruption processing ends.

While forms for carrying out the present invention have been described using the embodiments, the present invention is not limited to these embodiments at all, and various modifications and substitutions can be made without departing from the gist of the present invention.

What is claimed is:

1. An agent apparatus comprising:
a display controller configured to perform control of causing a display to display an agent which provides a service including causing an output unit to output a response using speech in response to an utterance of an occupant of a vehicle; and
a controller configured to control the agent on the basis of a situation of the occupant, an operating situation of the agent, and an operating situation of the vehicle,
wherein, when interruption control occurs in the course of service provision according to the agent, the display controller performs control of displaying interruption information that is information about the interruption and sub-interruption related information.

2. The agent apparatus according to claim 1, wherein the sub-interruption related information is notification information with respect to the service being provided by the agent.

3. The agent apparatus according to claim 1, wherein the display controller performs control of canceling display of the sub-interruption related information and then performs control of canceling display of the interruption information.

4. The agent apparatus according to claim 1, wherein the service is provided by each of a first agent and a second agent, and
the display controller limits display of the first agent when interruption control according to the second agent occurs in the course of display of the first agent.

5. The agent apparatus according to claim 4, wherein the controller ends display of the sub-interruption related information and resumes service provision according to the agent when the interruption control has ended.

6. The agent apparatus according to claim 5, wherein the controller temporarily stops service provision that has been being provided before the interruption control is started, and when the interruption control ends, resumes the temporarily stopped service provision.

7. The agent apparatus according to claim 6, wherein the controller resumes the service provision from the start of an utterance of the agent at a point in time at which the service provision is temporarily stopped.

8. The agent apparatus according to claim 5, wherein the controller temporarily stops service provision that has been being provided before the interruption control is started, additionally continuously executes processing with respect to details of service provision that has been being provided before the interruption control is started, and when the interruption control ends, resumes service provision according to the first agent on the basis of details of the temporarily stopped service provision and a result of the continuously executed processing.

9. The agent apparatus according to claim 1, wherein the controller changes a display mode of the sub-interruption related information on the basis of a waiting time during which service provision through the display is curbed.

10. A control method for controlling an agent apparatus including a display controller configured to perform control of causing a display to display an agent which provides a service including causing an output unit to output a response using speech in response to an utterance of an occupant of a vehicle, and a controller configured to control the agent on the basis of a situation of the occupant, an operating situation of the agent, and an operating situation of the vehicle, the control method comprising:
when interruption control occurs in the course of service provision according to the agent, causing, by a computer of the agent apparatus, the display controller to perform control of displaying interruption information that is information about the interruption and sub-interruption related information.

11. A computer-readable non-transitory storage medium storing a program causing a computer to:
perform control of causing a display to display an agent which provides a service including causing an output unit to output a response using speech in response to an utterance of an occupant of a vehicle; and
control the agent on the basis of a situation of the occupant, an operating situation of the agent, and an operating situation of the vehicle,
wherein, when interruption control occurs in the course of service provision according to the agent, the computer is caused to perform control of displaying interruption information that is information about the interruption and sub-interruption related information.
